(19) United States
(12) Patent Application Publication
(10) Pub. No.: US 2008/0182562 A1
(43) Pub. Date: Jul. 31, 2008

(54) Method Permitting the Monitoring of a Non-Real Time Data Connection Context of a User of a Cellular Mobile Radio Network

(75) Inventors: Olaf Bohme, Berlin (DE); Uwe Foll, Falkensee (DE)

Correspondence Address: STAAS & HALSEY LLP, SUITE 700, 1201 NEW YORK AVENUE, N.W., WASHINGTON, DC, 20005, US

(73) Assignee: NOKIA SIEMENS NETWORKS GMBH & CO. KG, 81541 MUNCHEN (DE)

(21) Appl. No.: 11/793,492

(22) PCT Filed: Dec. 7, 2005
(86) PCT No.: PCT/EP05/56580

§ 371 Date: Dec. 18, 2007

(30) Foreign Application Priority Data
Dec. 21, 2004 (DE) 10 2004 061 523.3

(51) Int. Cl. H04M 3/42

(52) U.S. Cl. 455/414.2

(57) ABSTRACT

An efficient monitoring of non-real time data connection contexts is simply and efficiently achieved by a method permitting the monitoring of a non-real time data connection context of a user of a cellular mobile radio network for an interruption, characterized in that a signaling context for the user is established as a real-time signaling context with the mobile radio network and, in the case of a determined interruption of the real-time signaling context for the user are assumed.

### CROSS REFERENCE TO RELATED APPLICATIONS

This application is based on and hereby claims priority to PCT Application No. PCT/EP2005/056580 filed on Dec. 7, 2005 and European Application No. 10 2004 061 523.3 filed on Dec. 21, 2004, the contents of which are hereby incorporated by reference.

### BACKGROUND OF THE INVENTION

Mobile radio networks (and in particular packet-switched mobile radio networks such as GPRS/UMTS/etc. networks) are known to a person skilled in the art, for example from the standardizations of mobile radio networks of this type (see e.g. www.etsi.org and www.3GPP.com). In a packet-switched mobile radio network, data is transmitted from or to a user of the cellular mobile radio network in packets via so-called contexts (corresponding e.g. to virtual channels) of data connections. In this respect, packet data is transmitted to one or more data connections via one or more physical data channels in that, for the purposes of a data connection, it is defined in each case, at least at both ends of the physical connection from the user to the mobile radio network, by a context, which of the packets transmitted via said at least one physical channel belong to which data connection of which user (for example by entries in a header of a packet, which header can be assigned to a data connection and/or a user at least at both ends of a channel). Details relating to this are known to a person skilled in the art from packet-switched mobile radio networks such as GPRS or 3G, which are already known in themselves.

Connections of this type, for example GPRS and/or PDP contexts, can be routed via (at least) one air interface of a mobile radio network. In particular, they can be established by the user (that is to say with the user's mobile terminal) and theoretically remain in existence for any desired length of time. Cleardown of the contexts can be effected by the users. It is possible for a data connection of this type on the air interface of a mobile radio network to be interrupted by an external event, for example if the user travels with his or her terminal into

an underground car park or a tunnel or the air interface is disrupted in some other way. In this case, the terminal cannot signal the cleardown of the data connection (or the context relating to the data connection) to the mobile radio network due to the interrupted air interface. In the event of non-real-time data connections (contexts), as are in very widespread use for packet switching in mobile radio networks, no monitoring of the air interface takes place in this regard. It is therefore not recognized within the mobile radio network that the connection has been interrupted; the connection and the context therefore continues to remain in existence within the network. However, on the one hand resources within the mobile radio network are unnecessarily (still) classified as reserved (because they are not released), and on the other hand costs are billed to the user, by a charging of his or her contexts/data connections, for the resources that are still reserved (data connections/contexts). The mobile radio network is therefore only utilizing its resources in a less than optimum manner and the charging is not optimum either.

### SUMMARY OF THE INVENTION

One possible object of the present invention is to handle a disruption of data connections or contexts of data connections in the case of an interruption of an air interface as efficiently and reliably as possible.

The inventors found that detection of an interruption of an air interface via which a data connection or a context relating to a data connection is routed is enabled surprisingly simply and efficiently by the establishment of a signaling context for the user (at which the data connection context was created) as a signaling context classified as real-time-capable.

Signaling contexts are used on the part of a user (in particular a terminal) for the establishment and the checking of the, or all, contexts of the user. The signaling contexts do not usually need to be established as real-time-capable for this purpose. However, a monitoring of real-time connections on the air interface of a mobile radio network can be implemented relatively readily in mobile radio networks. If a real-time connection of this type is interrupted, this is recognized on the part of the mobile radio network and the relevant resources of the user are released, for example, (that is to say the context for which an interruption on the air interface has been detected is released or deleted or terminated) or managed down to a minimum (quality of service update: maximum bit rate=0), etc. In the event of a user who also has at least one active “real-time” context at his or her disposal in addition to non-real-time contexts, the resources of the “non-real-time” contexts can also be monitored by monitoring of the real-time contexts and released or modified where relevant. If a user gets the connection back (he or she has, to this end, a connection via the air interface again, etc.) and context resources still exist, the connections (contexts) can be synchronized. The quality requirements (quality of service) can be negotiated back again. The area with the minimum quality of service can be recorded separately in a charging file (charging ticket) relating to the user and his or her data connection and can be ignored during the billing (calculation of the charges for the user and his or her data connection context (E)).

The method therefore enables the detection of interruptions on the air interface and therefore of non-real-time data connection contexts for that user simply and efficiently by the establishment of a signaling context for a user as a real-time signaling context.

The method can be utilized in the most diverse mobile radio networks, in particular in cellular packet-switched mobile radio networks such as, for example, GPRS/3G or other packet-switched cellular mobile radio networks.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows, in schematic form, the communication between a user (terminal) and a mobile radio network.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

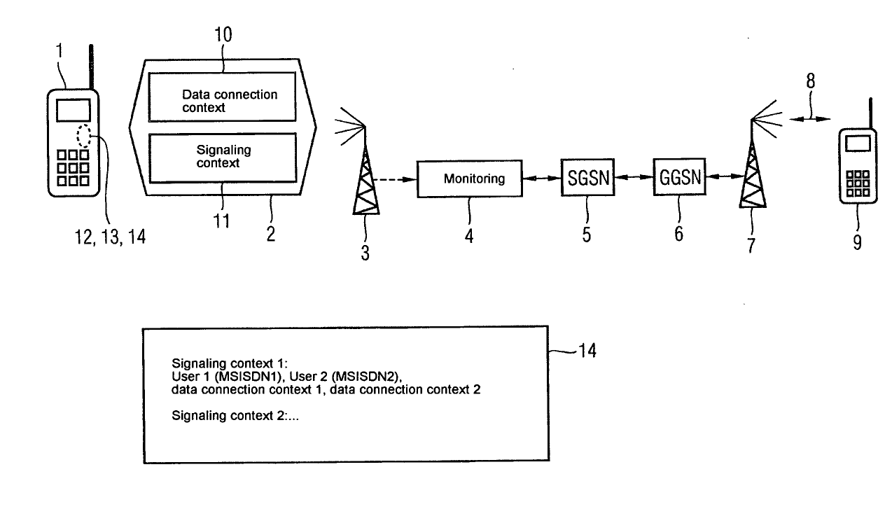

FIG. 1 shows, in schematic form, the communication of a user 1 with a mobile radio terminal MS1 via an air interface 2, a mobile radio network base station 3 of a cellular mobile radio network with a monitoring facility 4 and switching facilities 5, 6 with, for example, a further mobile station 9 (via a further base station 7 and a further air interface 8).

The transmission of data between the mobile station 1 and the mobile radio network (3, 4, 5, 6, 7) via the air interface 2 can be effected in principle by circuit switching, it being possible to through-connect a physical line from the mobile radio terminal of the user 1 to the mobile radio terminal 9, etc., or by packet switching, it being possible to transmit data to be transmitted from a mobile station 1 to a further mobile station 9 via one or more physical channels in (e.g. virtual) packet-switched connections. In the event of the transmission of data from or to the mobile station via one or more data connections to the mobile radio network in packets, data relating to a plurality of data connections could be transmitted in one (or a plurality of) physical channel(s) and be assigned to a context, that is to say a data connection, on the basis of an assignment of identification codes in data packets (headers), at the recipient (mobile radio network or mobile station, etc.).

In the event of the transmission of packet data via an air interface 2 of a mobile radio network, an interruption of the air interface by external events such as, for example, an underground car park or a tunnel and therefore an interruption of a data connection (chargeable to the user under certain circumstances) should be detected. However, data connections of this type are implemented as non-real-time data connections on a widespread basis (real-time data connections comprise data connections for which minimum average and/or maximum transmission rates or transmission times are guaranteed universally or for certain conditions, while they are not usually guaranteed for non-real-time data connections, etc.).

The monitoring of (at least) one non-real-time data connection context 10 of this type of a user 1, via which (10) data is transmitted (for Internet transmissions, e-mail data, and any other desired data) is effected in that a signaling context 11 for the user is established or defined (on the part of the mobile station and the mobile radio network informed by it) as a real-time signaling context, which is monitored by the mobile radio network, wherein in the event of a detection of an interruption of the signaling context (monitored as “real-time-capable” due to the definition) for the user, an interruption of one or all data connection contexts 10 for that user is assumed by the mobile radio network and/or by the mobile radio terminal 1. Then a charge calculation for the data connection context can be started where relevant. Moreover, the data connection context can be classified definitively or provisionally as released (terminated) at the mobile radio network end and/or at the mobile radio terminal end and/or its quality or another property changed. With reference to a signaling context, saving to memory is appropriately performed, on the part of the mobile station and/or on the part of a facility of the mobile radio network, of which data connection contexts are assigned to which signaling text in such a way that they belong to the same user and/or that they are to be classified as terminated, etc. in the event of the detection of an interruption of the signaling context (on the air interface, etc.).

In a controller for the terminal 1, a facility 12 is therefore provided for establishing a signaling connection as a real-time context. In the terminal and in, for example, a monitoring facility 4 of a mobile radio network, etc., a memory 13 can be provided in each case in which the contexts used by the mobile station 1 can be saved in a file 14 as in the example, it being possible to save to memory, with reference to a signaling context, what properties it has and what data connection contexts have been created for the user 1 (via the signaling context, etc.). Data relating to properties of the context such as real-time capability/non-real-time capability, header, beginning and end of the data connection, quality, etc. can also be included with reference to data connection contexts.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A method for monitoring an interruption in a non-real-time data connection context of a user of a cellular mobile radio network, comprising:
establishing a real-time signaling context between the user and the mobile radio network via an air interface;
monitoring the real-time signaling context; and
if an interruption of the real-time signaling context is detected for the user, assuming that all data connection contexts have been interrupted for the user.

16. The method as claimed in claim 15, wherein
the real-time signaling context is monitored by a facility of the mobile radio network and/or a facility of the mobile radio terminal.

17. The method as claimed in claim 15, wherein
the real-time signaling context is monitored to detect an establishment of one of more data connections for the user and/or a modification of an established data connection for the user.

18. The method as claimed in claim 15, wherein
the real-time signaling context is monitored to detect quality changes to an established data connection and/or monitor interruptions in the established data connection.

19. The method as claimed in claim 15, wherein
if an interruption is detected in the air interface, an interruption of the real-time signaling context is assumed.

20. The method as claimed in claim 15, wherein
data associated with the data connection context is saved to a memory by a facility of the mobile radio network if an interruption of the real-time signaling context is detected.

21. The method as claimed in claim 15, wherein
the data connection context comprises a packet data protocol (PDP) connection.

22. The method as claimed in claim 15, wherein
the data connection context is a packet-switched data connection.

23. The method as claimed in claim 15, wherein
a data connection context is a general packet radio service (GPRS) data connection.

24. The method as claimed in claim 15, wherein
the user is charged for the data connection context, and
if an interruption is detected in the air interface, then charging the user for the data connection context is terminated, so that no further charges are logged for the data connection context in future.

25. The method as claimed in claim 15, wherein
the user comprises a mobile telecommunications terminal for a cellular mobile radio network.

26. The method as claimed in claim 15, wherein
the mobile radio network is a packet-switched mobile radio network, and
the data connection context is a channel via which payload data is transmitted in a packet-switched manner.

27. The method as claimed in claim 16, wherein
the real-time signaling context is monitored to detect an establishment of one of more data connections for the user and/or a modification of an established data connection for the user.

28. The method as claimed in claim 27, wherein
the real-time signaling context is monitored to detect quality changes to an established data connection and/or monitor interruptions in the established data connection.

29. The method as claimed in claim 28, wherein
if an interruption is detected in the air interface, an interruption of the real-time signaling context is assumed.

30. The method as claimed in claim 29, wherein
data associated with the data connection context is saved to memory by a facility of the mobile radio network if an interruption of the real-time signaling context is detected.

31. The method as claimed in claim 30, wherein
the user is charged for the data connection context, and
if an interruption is detected in the air interface, then charging the user for the data connection context is terminated, so that no further charges are logged for the data connection context in future.

32. The method as claimed in claim 31, wherein
the mobile radio network is a packet-switched mobile radio network, and
the data connection context is a channel via which payload data is transmitted in a packet-switched manner.

33. A mobile radio terminal for a cellular mobile radio network, comprising:
a connection unit to establish a real-time signaling connection via an air interface between a user and the mobile radio network;
a monitoring facility to monitor the real-time signaling connection; and
a decision-making facility for classifying a data connection for the user as being interrupted if the monitoring facility detects an interruption in the real-time signaling connection.

34. A device for a cellular mobile radio network, comprising:
a connection unit to establish a real-time signaling connection via an air interface between a user and the mobile radio network;
a monitoring facility to monitor the real-time signaling connection; and
a decision-making facility for classifying a data connection for the user as being interrupted if the monitoring facility detects an interruption in the real-time signaling connection.
